(19) United States
(12) Patent Application Publication
(10) Pub. No.: US 2026/0222431 A1
(43) Pub. Date: Jul. 30, 2026

(54) Anomaly Detection and Slice Isolation in a Communication Network

(71) Applicant: Telefonaktiebolaget LM Ericsson (publ), Stockholm (SE)

(72) Inventor: Hichem Sedjelmaci, Massy (FR)

(21) Appl. No.: 19/145,575

(22) PCT Filed: Jan. 9, 2023
(86) PCT No.: PCT/EP2023/050342

§ 371 Date: Jul. 3, 2025

(51) Int. Cl. H04L 9/40; H04L 41/142; H04L 41/16

(52) U.S. Cl. CPC H04L 63/1425; H04L 41/142; H04L 41/16

(57) ABSTRACT

Anomaly detectors are distributed in a communication network for detecting anomalies at respective targets in the communication network. Detection equipment for the communication network receives, from the anomaly detectors, anomaly reports that report detected anomalies. Based on the received anomaly reports, the detection equipment determines a reputation score of each anomaly detector for accurately or inaccurately detecting anomalies. The detection equipment controls whether and/or how each anomaly detector detects anomalies based on the reputation score determined for that anomaly detector.

### TECHNICAL FIELD

The present application relates generally to a communication network, and relates more particularly to detection of anomalies and/or isolation of network slices in such a communication network.

### BACKGROUND

A network slice is a logical network that provides specific network capabilities and network characteristics. An operator of a communication network can deploy multiple network slices over common physical network infrastructure in order to provide different logical networks for providing different respective network capabilities and network characteristics, e.g., for different services, customers, and/or providers. For example, different network slices may be dedicated to different respective services, such as Internet of Things (IoT) services, mission-critical services, mobile broadband services, etc. A network operator can also exploit network slicing to provide services such as network-as-a-service (NaaS) or network-as-a-platform (NaaP), so as to host numerous companies as tenants on respective slices. Network slicing in these and other contexts may be enabled with infrastructure virtualization, on-demand slice instantiation, and resource orchestration.

Network slicing nonetheless creates security challenges for guarding against attacks and other anomalies. For example, challenges exist regarding how to reliably detect a security attack on a network slice, especially in a way that is efficient and practical. An undetected security attack on one network slice threatens to degrade the performance of other, legitimate network slices, e.g., in terms of latency, bandwidth, and/or data rate. As another example, challenges exist regarding how to decide the extent to which slices should be isolated from one another, and the circumstances under which to dynamically impose such isolation. In these and other contexts, then, challenges exist in securing a communication network in a way that is reliable, efficient, and practical.

### SUMMARY

Some embodiments herein distribute anomaly detectors in a communication network for detecting anomalies at respective targets (e.g., network slices) in the communication network. The anomaly detectors report detected anomalies to detection equipment, e.g., centrally deployed at a higher hierarchical level in order to facilitate anomaly report collection and/or detector coordination. In receipt of anomaly reports, the detection equipment quantifies each anomaly detector's reputation for accurately or inaccurately detecting anomalies, e.g., as a function of the anomaly detector's false positive rate and/or false negative rate. The detection equipment then controls each anomaly detector based on that anomaly detector's reputation, e.g., by controlling whether and/or how each anomaly detector detects anomalies. The detection equipment may for example control which technique each anomaly detector uses to detect anomalies, e.g., to use a more accurate technique when a detector's reputation is low but to use a more resource-efficient technique when a detector's reputation is high. Alternatively or additionally, the detection equipment may control which anomaly detectors detect anomalies, e.g., by isolating anomaly detectors whose reputations are low. By controlling distributed anomaly detectors in these ways based on quantified detector reputations, some embodiments herein provide anomaly detection that flexibly accounts for both reliability and efficiency/practicality.

Separately or in combination, other embodiments herein include security management equipment that quantifies the level of trust to be given to each network slice of a communication network. The security management equipment quantifies the level of trust to be given to a network slice accounting for how accurately anomalies in the network slice have been detected, e.g., as reflected by the false positive rate and/or false negative rate of anomaly detection in the network slice. Alternatively or additionally, the security management equipment quantifies the level of trust to be given to a network slice accounting for how impactful anomaly detection in the network slice is on resources in the communication network, e.g., with the level of trust decreasing with increasing resource strain on the communication network. Regardless, the security management equipment controls how isolated each network slice is from other network slices, based on the level of trust to be given to that network slice, e.g., increasing isolation of network slices to be given low levels of trust. By controlling network slice isolation in this way, some embodiments herein dynamically impose network slice isolation to an extent and/or under circumstances reflecting desired detection reliability and efficiency.

More particularly, embodiments herein include a method performed by detection equipment for a communication network. The method comprises receiving, from anomaly detectors distributed in the communication network for detecting anomalies at respective targets in the communication network, anomaly reports that report detected anomalies. The method also comprises, based on the received anomaly reports, determining a reputation score of each anomaly detector for accurately or inaccurately detecting anomalies. The method further comprises controlling whether and/or how each anomaly detector detects anomalies based on the reputation score determined for that anomaly detector.

In some embodiments, controlling how an anomaly detector detects anomalies comprises selecting, based on the reputation score determined for the anomaly detector, a detection technique for the anomaly detector from among multiple detection techniques supported by the anomaly detector for detecting anomalies. In some embodiments, controlling how an anomaly detector detects anomalies comprises requesting or directing the anomaly detector to use the selected detection technique for detecting anomalies. In some embodiments, selecting the detection technique for the anomaly detector comprises selecting a first detection technique over a second detection technique if the reputation score of the anomaly detector for detecting anomalies accurately is below a first threshold. In other embodiments, selecting the detection technique for the anomaly detector comprises selecting the second detection technique over the first detection technique if the reputation score of the anomaly detector for detecting anomalies accurately is above a second threshold. In some embodiments, the first detection technique detects anomalies more accurately than the second detection technique but requires more resources than the second detection technique. In some embodiments, the detection techniques supported by at least one anomaly detector include at least a machine learning algorithm trained, using training data, to detect anomalies at the target monitored by the anomaly detector. In some embodiments, the detection techniques supported by at least one anomaly detector include at least a rule-based algorithm that detects anomalies at the target monitored by the anomaly based on one or more rules.

In some embodiments, the reputation score of an anomaly detector is determined as a function of a false positive rate and/or a false negative rate. In some embodiments, the false positive rate is a rate at which the anomaly detector incorrectly detects an anomaly, and the false negative rate is a rate at which the anomaly detector fails to detect an anomaly. In some embodiments, the reputation score of an anomaly detector is determined as:

$$R = {α}_{1} \cdot D - ( {α}_{2} \cdot {F}_{P} + {α}_{3} \cdot {F}_{N} ) ,$$

where R∈[−1,1] is the reputation score of the anomaly detector, α₁, α₂ and α₃∈[0,1] are weight parameters, D is a number of anomalies detected by the anomaly detector as reported over K anomaly reports, F_{P} is the false positive rate comprising a number of anomalies that were incorrectly detected by the anomaly detector over K anomaly reports, F_{N} is the false negative rate comprising a number of anomalies that the anomaly detector failed to detect over K anomaly reports. In some embodiments, controlling how an anomaly detector detects anomalies comprises controlling the anomaly detector to detect anomalies using a machine learning algorithm if the reputation score of the anomaly detector is less than 0. In this case, the machine learning algorithm is trained, using training data, to detect anomalies at the target monitored by the anomaly detector. In other embodiments, controlling how an anomaly detector detects anomalies comprises controlling the anomaly detector to detect anomalies using a rule-based algorithm that detects anomalies at the target monitored by the anomaly based on one or more rules, if the reputation score of the anomaly detector is greater than 0.

In some embodiments, the anomaly detectors are deployed in an access network of the communication network and the detection equipment is deployed at an edge server of the communication network. In other embodiments, the anomaly detectors are deployed at one or more edge servers of the communication network and the detection equipment is deployed in a core network of the communication network.

In some embodiments, controlling whether each anomaly detector detects anomalies based on the reputation score determined for that anomaly detector comprises inactivating or isolating the anomaly detector if the reputation score of that anomaly detector drops below a threshold.

In some embodiments, the detection equipment and each of the anomaly detectors is specific for a certain network slice of multiple network slices of the communication network.

Other embodiments herein include detection equipment for a communication network. The detection equipment is configured to receive, from anomaly detectors distributed in the communication network for detecting anomalies at respective targets in the communication network, anomaly reports that report detected anomalies. The detection equipment is also configured to, based on the received anomaly reports, determine a reputation score of each anomaly detector for accurately or inaccurately detecting anomalies. The detection equipment is also configured to control whether and/or how each anomaly detector detects anomalies based on the reputation score determined for that anomaly detector.

In some embodiments, the detection equipment is configured to perform the steps described above for detection equipment for a communication network.

In some embodiments, a computer program comprising instructions which, when executed by at least one processor of detection equipment, causes the detection equipment to perform the steps described above for detection equipment for a communication network. In some embodiments, a carrier containing the computer program is one of an electronic signal, optical signal, radio signal, or computer readable storage medium.

Other embodiments herein include a method performed by security management equipment for a communication network. The method comprises computing, for each of one or more network slices of the communication network, a level of trust to be given to the network slice, accounting for how accurately anomalies in the network slice have been detected and how impactful anomaly detection in the network slice is on resources in the communication network. The method also comprises controlling how isolated each of the one or more network slices is from other network slices, based on the level of trust to be given to that network slice.

In some embodiments, said controlling comprises increasing isolation of a network slice if the level of trust to be given to that network slice is below a threshold level of trust.

In some embodiments, the level of trust computed for each network slice accounts for how accurately anomalies in the network slice have been detected by accounting for a false positive rate and/or a false negative rate of anomaly detection in the network slice. In this case, the false positive rate is a rate at which anomalies in the network slice have been incorrectly detected, and the false negative rate is a rate at which anomalies have failed to be detected in the network slice.

In some embodiments, the level of trust computed for each network slice accounts for how impactful anomaly detection in the network slice is on resources in the communication network by accounting for an extent to which resources required for detecting anomalies in the network slice with a threshold level of accuracy are consumed.

In some embodiments, the level of trust is computed for each network slice as a function of at least a known anomaly detection rate comprising a rate at which anomalies of known type have been detected in the network slice. In other embodiments, the level of trust is computed for each network slice alternatively or additionally as a function of at least an unknown anomaly detection rate comprising a rate at which anomalies of unknown type have been detected in the network slice. In yet other embodiments, the level of trust is computed for each network slice alternatively or additionally as a function of at least a relative information rate comprising a rate of anomaly reports from anomaly detectors required to detect anomalies in the network slice with a threshold level of accuracy. In still yet other embodiments, the level of trust is computed for each network slice alternatively or additionally as a function of at least a false positive rate comprising a rate at which anomalies in the network slice have been incorrectly detected. In still yet other embodiments, the level of trust is computed for each network slice alternatively or additionally as a function of at least a false negative rate comprising a rate at which anomalies have failed to be detected in the network slice. In still yet other embodiments, the level of trust is computed for each network slice alternatively or additionally as a function of at least a network cost rate comprising a rate of resources required for detecting anomalies in the network slice with a threshold level of accuracy. In some embodiments, the level of trust is computed for each network slice as:

$$T = β * {T}_{G} - {β}^{′} * {T}_{B}$$

$${T}_{G} = {D}_{RADA} + {D}_{EADA} + {D}_{EADA}^{′} + {D}_{CADA}^{′} + {RIT}_{RADA} + {RIT}_{EADA}$$

$${T}_{B} = {F}_{RADA} + {F}_{EADA} + {F}_{CADA} + {NCR}_{RADA} + {NCR}_{EADA} + {NCR}_{CADA} .$$

In some embodiments, T is the level of trust for the network slice, β and β′∈[0,1] are weight parameters, T_{G} is a good trust level parameter, T_{B} is a bad trust level parameter, D_{RADA} is the known anomaly detection rate in an access network of the communication network, D_{EADA} is the known anomaly detection rate in one or more edge servers of the communication network, D′_{EADA} is the unknown anomaly detection rate in one or more edge servers of the communication network, D′_{CADA} is the unknown anomaly detection rate in a core network of the communication network, RIT_{RADA} is the relative information rate in the access network, RIT_{EADA} is the relative information rate in the one or more edge servers, F_{RADA} is an access network false detection rate comprising a sum of the false negative rate and the false positive rate in the access network, F_{EADA} is an edge false detection rate comprising a sum of the false negative rate and the false positive rate in the one or more edge servers, F_{EADA} is a core network false detection rate comprising a sum of the false negative rate and the false positive rate in the core network, NCR_{RADA} is the network cost rate in the access network, NCR_{EADA} is the network cost rate in the one or more edge servers, and NCR_{CADA} is the network cost rate in the core network. In some embodiments, said controlling comprises increasing isolation of a network slice if β′*T_{B}>>β*T_{G} and |T*| is less than a threshold, where

$${T}^{*} = {max}_{{T}_{B}} {min}_{{T}_{G}} T ( {T}_{G} , {T}_{B} ) .$$

Other embodiments herein include security management equipment for a communication network. The security management equipment is configured to compute, for each of one or more network slices of the communication network, a level of trust to be given to the network slice, accounting for how accurately anomalies in the network slice have been detected and how impactful anomaly detection in the network slice is on resources in the communication network. The security management equipment is also configured to control how isolated each of the one or more network slices is from other network slices, based on the level of trust to be given to that network slice.

In some embodiments, the security management equipment is configured to perform the steps described above for security management equipment for a communication network.

In some embodiments, computer program comprising instructions which, when executed by at least one processor of security management equipment, causes the security management equipment to perform the steps described above for security management equipment for a communication network. In some embodiments, a carrier containing the computer program is one of an electronic signal, optical signal, radio signal, or computer readable storage medium.

Other embodiments herein include detection equipment for a communication network. The detection equipment comprises communication circuitry and processing circuitry. The processing circuitry is configured to receive, via the communication circuitry, from anomaly detectors distributed in the communication network for detecting anomalies at respective targets in the communication network, anomaly reports that report detected anomalies. The processing circuitry is also configured to, based on the received anomaly reports, determine a reputation of each anomaly detector for accurately or inaccurately detecting anomalies. The processing circuitry is also configured to control whether and/or how each anomaly detector detects anomalies based on the reputation determined for that anomaly detector.

In some embodiments, the processing circuitry is configured to perform the steps described above for detection equipment for a communication network.

Other embodiments herein include security management equipment for a communication network. The security management equipment comprises communication circuitry and processing circuitry. The processing circuitry is configured to compute, for each of one or more network slices of the communication network, a level of trust to be given to the network slice, accounting for how accurately anomalies in the network slice have been detected and how impactful anomaly detection in the network slice is on resources in the communication network. The processing circuitry is also configured to control how isolated each of the one or more network slices is from other network slices, based on the level of trust to be given to that network slice.

In some embodiments, the processing circuitry is configured to perform the steps described above for security management equipment for a communication network.

Of course, the present disclosure is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a block diagram of distributed anomaly detectors and detection equipment according to some embodiments.

FIG. 2 is a block diagram of a controller for controlling an anomaly detector according to some embodiments.

FIG. 3 is a block diagram of a controller for controlling how an anomaly detector detects anomalies according to some embodiments.

FIG. 4 is a block diagram of a controller for controlling whether an anomaly detector detects anomalies according to some embodiments.

FIG. 5A is a block diagram of a hierarchical distribution of detection equipment and anomaly detectors according to some embodiments.

FIG. 5B is a block diagram of a hierarchical distribution of detection equipment and anomaly detectors according to other embodiments.

FIG. 6A is a block diagram of slice-specific detection equipment and anomaly detectors according to some embodiments.

FIG. 6B is a block diagram of slice-specific detection equipment and anomaly detectors, combined with hierarchical distribution, according to some embodiments.

FIG. 7 is a block diagram of security management equipment according to some embodiments.

FIG. 8 is a block diagram of a controller for controlling an extent to which a network slice is isolated according to some embodiments.

FIG. 9 is a logic flow diagram of a method for controlling an extent to which a network slice is isolated according to some embodiments.

FIG. 10 is a logic flow diagram of a method performed by detection equipment for a communication network according to some embodiments.

FIG. 11 is a logic flow diagram of a method performed by security management equipment according to some embodiments.

FIG. 12 is a block diagram of detection equipment for a communication network according to some embodiments.

FIG. 13 is a block diagram of security management equipment according to some embodiments.

FIG. 14 shows an example of a communication system in accordance with some embodiments.

FIG. 15 is a block diagram of a host which may be an embodiment of the host of FIG. 14, in accordance with various aspects described herein.

### DETAILED DESCRIPTION

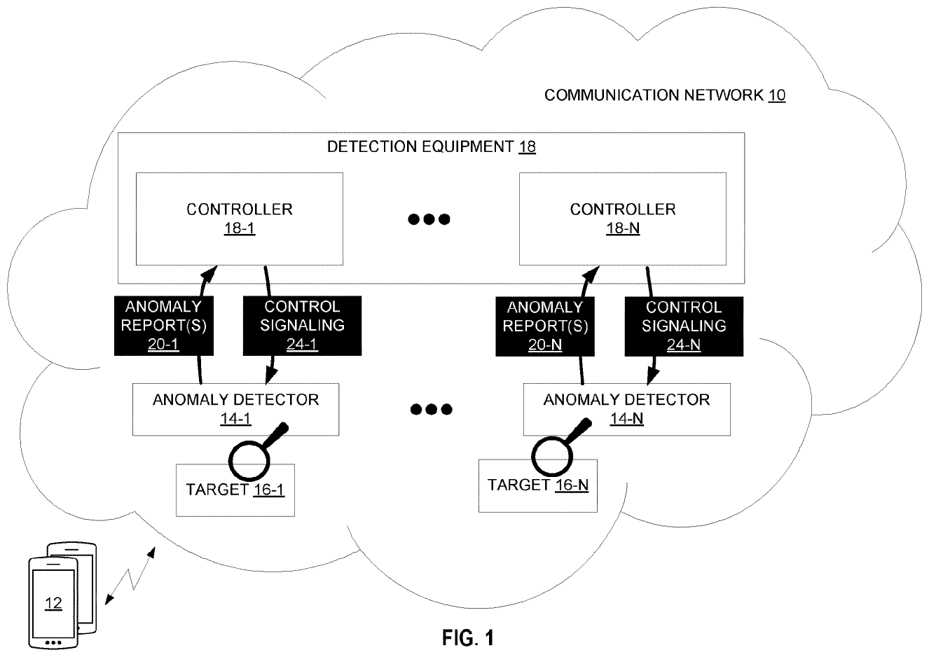

FIG. 1 shows a communication network 10 (e.g., a 5G+ network) according to some embodiments. The communication network 10 provides communication service to one or more communication devices 12, e.g., user equipment (UE). The communication network 10 may for example provide wireless communication service to the one or more communication devices 12.

The communication network 10 includes multiple anomaly detectors 14-1 . . . 14-N, generally referred to as anomaly detectors 14. Each anomaly detector 14-n (1≤n≤N) is configured to detect anomalies in the communication network 10. An anomaly as used herein refers to a deviation from what is standard, normal, or expected in the communication network 10. An anomaly, for example, may be an attack on the communication network 10 (e.g., a denial of service attack), or may be the direct or indirect impact of such an attack (e.g., a higher rate of access request rejection due to overloading, a lower number of connected devices, lower system throughput, etc.). An anomaly detector 14-n in such an example may be configured to detect an attack itself, or may be configured to detect the direct or indirect impact of such an attack. Generally, though, an anomaly detector 14-n detects an anomaly in the sense that the anomaly detector 14-n detects some sort of deviation from what is standard, normal, or expected, e.g., where a decision on the existence of a deviation may be made based on a machine learning model reflecting what is standard, normal, or expected.

An anomaly detector 14-n may or may not itself understand the full implication of an anomaly that it detects. In one embodiment, for example, an anomaly detector 14-n that detects an anomaly in the form of a higher-than-normal rate of access request rejection may or may not be configured to attribute that anomaly to an attack, much less a certain kind of attack such as a denial-of-service attack. In another embodiment, by contrast, an anomaly detector 14-n may itself detect an anomaly in the form of a certain kind of attack.

No matter the particular form of anomalies that the anomaly detectors 14 are configured to detect, the anomaly detectors 14 detect anomalies at respective targets 16-1 . . . 16-N in the communication network 10, generally referred to as targets 16. A target 16 as used herein refers to any network node or function that an anomaly detector scrutinizes for evidence of the existence of an anomaly. In one embodiment, an anomaly detector 14-n may be co-located with the target 16-n at which the anomaly detector 14-n detects anomalies. In this and other embodiments, the distribution of anomaly detectors 14 may reflect the distribution of the targets 16 at which the anomaly detectors 14 detect anomalies.

The anomaly detectors 14 and/or the targets 16 may be distributed in one or more dimensions, which may for example include geography and/or functionality. In some embodiments, for instance, at least some of the anomaly detectors 14 and/or the targets 16 are geographically distributed in the communication network 10, e.g., at different parts of the communication network's coverage area. Alternatively or additionally, at least some of the anomaly detectors 14 and/or the targets 16 may be functionally distributed in the communication network 10, e.g., for detecting anomalies at different types of network functions or network equipment.

Regardless, the anomaly detectors 14 each report detected anomalies to detection equipment 18 in the communication network 10, by sending the detecting equipment 18 anomaly reports 20-1 . . . 20-N (also referred to as anomaly messages and generally referred to as anomaly reports 20). An anomaly report 20-n sent by an anomaly detector 14-n may include information about the target 16-n at which the anomaly was detected, e.g., an identity of the target, a location of the target, and/or a type of the target. An anomaly report 20-n may alternatively or additionally include information about the reported anomaly, e.g., the type of the anomaly and/or evidence of the anomaly's occurrence, such as measurement results or features based on which the anomaly's occurrence was detected.

Regardless of the particular content of the anomaly reports 20, the detection equipment 18 in some embodiments operates as a common point of contact for the anomaly detectors 14, for centralized collection of anomaly reports 20 from the different anomaly detectors 14 that are distributed in the communication network 10. So deployed, the detection equipment 18 may scrutinize, combine, or otherwise evaluate anomaly reports collectively across the distributed anomaly detectors 14, e.g., as part of assessing the accuracy or inaccuracy of each anomaly report.

In receipt of anomaly reports 20 from the anomaly detectors 14, the detection equipment 18 is configured to correspondingly control the anomaly detectors 14. FIG. 1 in this regard shows that the detection equipment 18 functionally includes controllers 18-1 . . . 18-N for controlling respective ones of the anomaly detectors 14-1 . . . 14-N. In one embodiment, for example, controller 18-1 sends control signaling 24-1 to anomaly detector 14-1 for controlling anomaly detector 14-2, controller 18-2 sends control signaling 24-2 to anomaly detector 14-2 for controlling anomaly detector 14-2, and so on. In some embodiments, the detection equipment 18 controls the anomaly detectors 14 in the sense that the detection equipment 18 controls whether and/or how each anomaly detector 14-n detects anomalies.

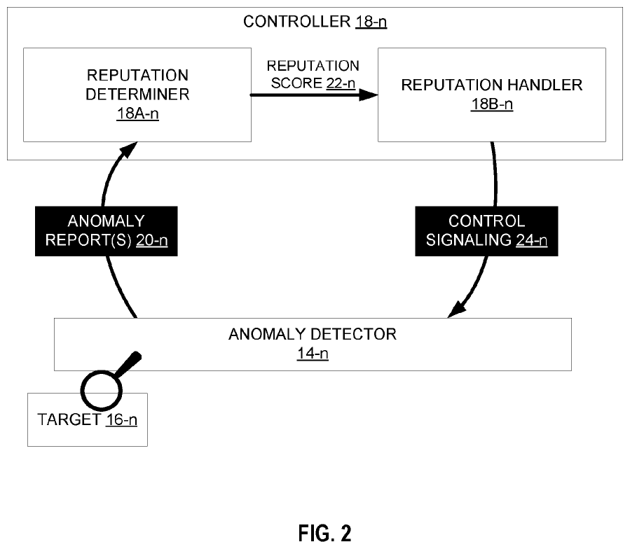

FIG. 2 illustrates additional details of anomaly detector control according to some embodiments where detector reputation drives or otherwise governs detector control. As shown, a controller 18-n controls operation of an anomaly detector 14-n configured to detect anomalies at a target 16-n. The anomaly detector 14-n transmits, to the controller 18-n, anomaly reports 20-n that report anomalies detected by the anomaly detector 14-n.

Based on the anomaly reports 20-n, a reputation determiner 18A-n of the controller 18-n quantifies the anomaly detector's reputation for accurately or inaccurately detecting anomalies. This quantification of the anomaly detector's reputation is referred to as a reputation score 22-n, i.e., the reputation score 22-n determined for the anomaly detector 14-n quantifies the anomaly detector's reputation for accurately or inaccurately detecting anomalies. The reputation score 22-n may for example be a value between −1.0 and 1.0, with a higher reputation value generally indicating a reputation for more accurate anomaly detection and a lower reputation value generally indicating a reputation for less accurate anomaly detection. Calculation or assignment of the reputation score 22-n may be performed according to a defined protocol, referred to herein as a reputation protocol.

As one example, the reputation score 22-n may be proportional in value to a statistical accuracy with which the anomaly detector 14-n has historically detected anomalies. As another example, the reputation score 22-n may increase in value with the rate at which the anomaly detector 14-n detects anomalies, but decrease in value with the rate at which the anomaly detector 14-n incorrectly detects anomalies (i.e., the false positive rate) and/or the rate at which the anomaly detector 14-n fails to detect anomalies (i.e., the false negative rate), e.g., with these rates being computed over a certain historical time period or a certain number of anomaly reports. In one specific implementation, the reputation determiner 18A-n may calculate the reputation score 22-n as:

$$R = {α}_{1} \cdot D - ( {α}_{2} \cdot {F}_{P} + {α}_{3} \cdot {F}_{N} ) ,$$

where R∈[−1,1] is the reputation score 22-n of the anomaly detector 14-n, α₁, α₂ and α₃∈[0,1] are weight parameters, D is a number of anomalies detected by the anomaly detector 14-n as reported over K anomaly reports, F_{P} is the false positive rate computed as the number of anomalies that were incorrectly detected by the anomaly detector 14-n over K anomaly reports, and F_{N} is the false negative rate computed as the number of anomalies that the anomaly detector 14-n failed to detect over K anomaly reports. In this implementation, the greater the number of anomalies accurately detected, the higher the reputation score 22-n of the anomaly detector 14-n. However, the higher the false positive rate F_{P} and/or the higher the false negative rate F_{N}, the lower the reputation sore 22-n, as the reputation score 22-n is penalized for inaccurately detected anomalies and missed anomalies.

As these examples demonstrate, then, an anomaly detector's reputation, as quantified by its reputation score 22-n, may generally characterize the anomaly detector's tendency or propensity for detecting anomalies accurately or inaccurately, e.g., as judged by the controller 18-n based on the anomaly detector's past behavior. In some embodiments, the reputation determiner 18A-n updates the anomaly detector's reputation score 22-n over time, e.g., as anomaly reports 20-n are received from the anomaly detector 14-n.

To support determination of the reputation score 22-n in these embodiments, the controller 18-n may accordingly scrutinize and otherwise verify anomaly reports 20-n from the anomaly detector 14-n for accuracy, e.g., using a deep learning algorithm. The controller 18-n may for example collect anomaly reports 20 from multiple anomaly detectors 14, and use a machine learning model or a consensus algorithm to decide which of the anomaly detectors 14 reported anomalies accurately. In this way, anomaly detection accuracy improves over time.

In any event, with the reputation score 22-n generated, the reputation determiner 18A-n in FIG. 2 provides this reputation score 22-n to a reputation handler 18B-n of the controller 18-n. The reputation handler 18B-n controls the anomaly detector 14-n based on the reputation score 22-n for that anomaly detector 14-n, e.g., by controlling whether and/or how the anomaly detector 14-n detects anomalies. The reputation handler 18B-n as shown in this regard generates, and transmits to the anomaly detector 14-n, control signaling 24-n for controlling the anomaly detector 14-n. The control signaling 24-n may for example convey a request or command governing whether and/or how the anomaly detector 14-n is to detect anomalies.

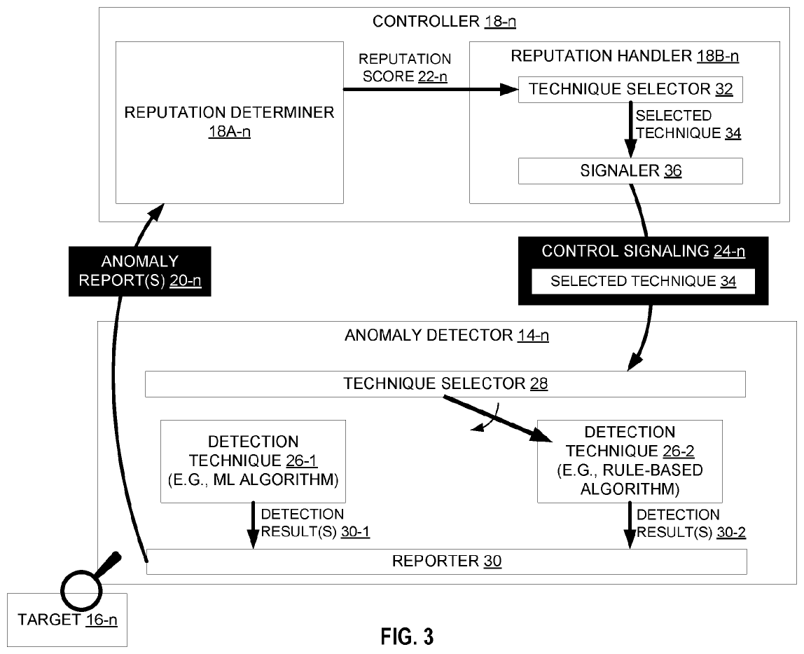

FIG. 3 illustrates additional details for anomaly detector control according to some embodiments where the anomaly detector 14-n supports multiple detection techniques. As shown, the anomaly detector 14-n supports at least a first detection technique 26-1 and a second detection technique 26-2 for detecting anomalies. The first and second detection techniques 26-1, 26-2 are different techniques for detecting anomalies.

In one example, the first detection technique 26-1 is a machine learning (ML) algorithm, e.g., trained, using training data, to detect anomalies at the target 16-n. The ML algorithm may for example be a lightweight binary (i.e., two classes) ML algorithm, such as a Support Vector Machine (SVM) algorithm, that classifies observations of the target 16-n as being normal behavior or an anomaly.

The second detection technique 26-2 by contrast may be a rule-based algorithm, e.g., that detects anomalies at the target 16-n based on one or more rules. One rule may for example specify the number of packets sent, received, or dropped as features evidencing a denial-of-service attack. Another rule may specify signal strength intensity as a feature evidencing a jamming attack.

No matter the particular techniques, the first and second detection techniques 26-1, 26-2 in some embodiments detect anomalies with different levels of accuracy and/or require different amounts of resources, e.g., different amounts of compute resources, communication resources, and/or storage resources. For example, the first detection technique 26-1 may detect anomalies more accurately than the second detection technique 26-2, but require more resources than the second detection technique 26-2. The first and second detection techniques 26-1, 26-2 in such a case present different options for a tradeoff between detection accuracy and resource efficiency.

In this context, FIG. 3 shows that the reputation handler 18B-n of the controller 18-n includes a technique selector 32 configured to select the detection technique 34 to be used by the anomaly detector 14-n, from among the multiple supported detection techniques 26-1, 26-2. The technique selector 32 selects this detection technique 34 based on the reputation score 22-n of the anomaly detector 14-n.

Consider an example where the first detection technique 26-1 detects anomalies more accurately than the second detection technique 26-2, but requires more resources than the second detection technique 26-2. In this case, where a higher value of the reputation score 22-n indicates a reputation for detecting anomalies more accurately, the technique selector 32 may select the first (more accurate) detection technique 26-1 if the reputation score 22-n is below a first threshold, e.g., if R<0 or α₁·D<(α₂·F_{P}+α₃·F_{N}). This operates to improve detection accuracy if the detector's reputation for accuracy drops. On the other hand, the technique selector 32 may select the second (more resource efficient) detection technique 26-2 if the reputation score 22-n is above a second threshold (which may be the same as or different than the first threshold), e.g., if R>0 or α₁·D>(α₂·F_{P}+α₃·F_{N}). This operates to improve resource efficiency if the detector's reputation for accuracy is high enough to warrant a less accurate detection technique, in favor of increased resource efficiency.

In some embodiments, the technique selector 32 makes its technique selection on a dynamic basis, as the reputation score 22-n changes over time, as needed to adapt the detection technique 34 used, e.g., for realizing a desired balance between detection accuracy and resource efficiency. In such a case, overtime, the detection technique used is a combination or hybrid of the multiple supported detection techniques 26-1, 26-2, with different techniques used at different times or under different circumstances, resulting in anomaly detection that is robust to changing circumstances.

In any event, after selection of the technique 34 that the anomaly detector 14-n is to use for anomaly detection, a signaler 36 generates control signaling 24-n that indicates the selected technique 34. The control signaling 24-n may for example include a request to the anomaly detector 14-n to use the selected technique 34. Or, the control signaling 24-n may be a command or direction to the anomaly detector 14-n to use the selected technique 34. Either way, the signaler 36 transmits the control signaling 24-n to the anomaly detector 14-n in order to control which detection technique the anomaly detector 14-n uses.

A technique selector 28 at the anomaly detector 14-n selects which detection technique it uses, based on this control signaling 24-n. The technique selector 28 may for example determine which detection technique 26-1, 26-2 is indicated by the control signaling 24-n. The technique selector 28 may then select which detection technique to actually use, taking into account the controller's request or command/direction to use the indicated technique 34.

A reporter 30 at the anomaly detector 14-n non-discriminately reports any anomalies detected, irrespective of which detection technique 26-1, 26-2 is used to detect those anomalies. As shown, for example, the reporter 30 receives as input any detection result(s) 30-1 attributable to the first detection technique 26-1 as well as any detection result(s) 30-2 attributable to the second detection technique 26-2. The anomaly report(s) 20-n from the reporter 30 thereby reflect anomalies detected by the anomaly detector 14-n as a whole, across the multiple supported detection techniques 26-1, 26-2. By extension, the reputation score 22-n of the anomaly detector 14-n reflects the accuracy or inaccuracy of the anomaly detector 14-n as a whole, combined across the multiple supported detection techniques 26-1, 26-2.

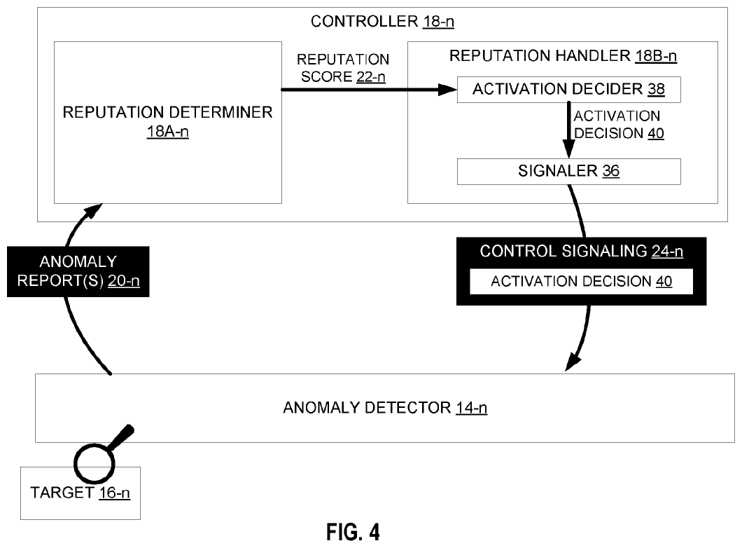

FIG. 4 illustrates other embodiments where the controller 18-n alternatively or additionally controls whether the anomaly detector 14-n is to detect anomalies. As shown, the reputation handler 18B-n alternatively or additionally includes an activation decider 38. The activation decider 38 decides, based on the anomaly detector's reputation score 22-n, whether the anomaly detector 14-n is to be active or inactive for detecting anomalies at the target 16-n. For example, the activation decider 38 may decide that the anomaly detector 14-n is to be inactive if the reputation score 22-n drops below a threshold, e.g., −0.75, but that the anomaly detector 14-n is to otherwise be active. In this case, the anomaly detector 14-n is inactivated if it acquires the reputation of having very poor accuracy in detecting anomalies. Regardless, FIG. 4 shows that the resulting activation decision 40 is propagated to the signaler 36, which transmits control signaling 24-n to the anomaly detector 14-n indicating the activation decision 40. The control signaling 24-n may indicate the activation decision 14 by requesting or commanding/directing the anomaly detector 14-n to be active or inactive, consistent with the activation decision 40. In some embodiments, the anomaly detector 14-n is configured to abide by this control signaling 24-n.

Although not shown, the signaler 36 may alternatively or additionally indicate its activation decision 40 to one or more other components of the controller 18-n (e.g., reputation determiner 18A-n) and/or to one or more other components in the communication network 10, as part of enforcing its activation decision 40. For example, if the activation decision 40 is that the anomaly detector 14-n is to be inactive, the one or more other components may disregard any anomaly reports 20-n received from the anomaly detector 14-n. In these and other embodiments, then, an activation decision 40 that inactivates the anomaly detector 14-n may effectively isolate the anomaly detector 14-n, e.g., so that its anomaly reports have no impact on and are effectively removed from the communication network 10. Accordingly, although the controller 18-n in FIG. 4 is illustrated as using the reputation score 22-n to determine whether the anomaly detector 14-n is to be active or inactive, the controller 18-n in other embodiments may instead use the reputation score 22-n to determine whether or not to isolate the anomaly detector 14-n.

In fact, in some embodiments, the reputation score threshold for the activation or isolation decision targets the inactivation or isolation of malicious anomaly detectors that are artificially withholding anomaly detection and/or reporting for malicious purposes. In this case, an anomaly detector's reputation score 22-n dropping below this threshold may be attributable to an unusually low rate of anomaly reporting and/or an unusually high rate of inaccurate anomaly reporting. The controller 18-n in this case may suspect the anomaly detector 14-n as malicious and correspondingly inactivate or isolate the anomaly detector 14-n.

In some embodiments, at least some of the controllers 18-1 . . . 18-N of the detection equipment 18 are co-located with one another. In other embodiments, at least some of the controllers 18-1 . . . 18-N of the detection equipment 18 are distributed, e.g., co-located with the respective targets 16-1 . . . 16-N. In this latter case, though, any distributed controllers may still be configured to coordinate with one another as part of collectively evaluating anomaly reports across the distributed anomaly detectors 14-1 . . . 14-N.

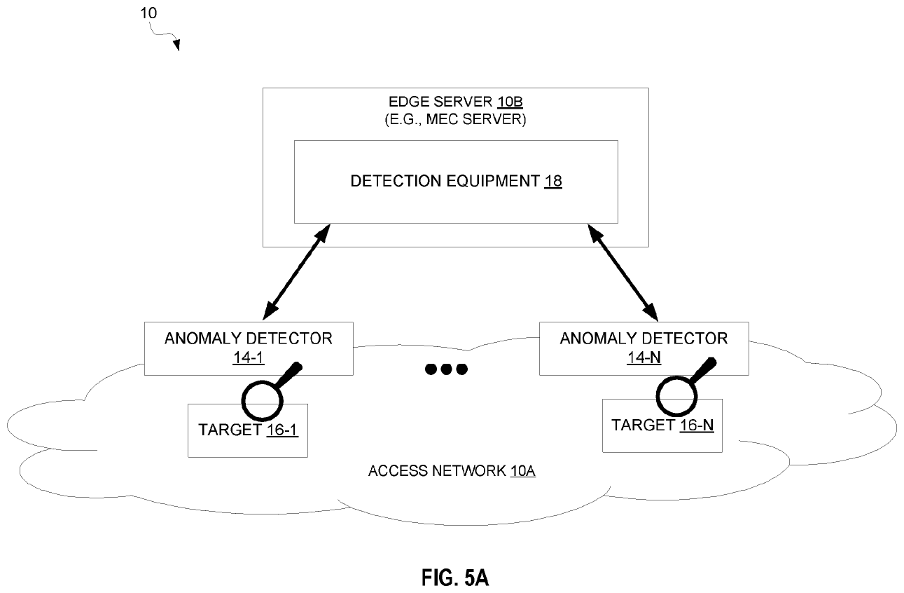

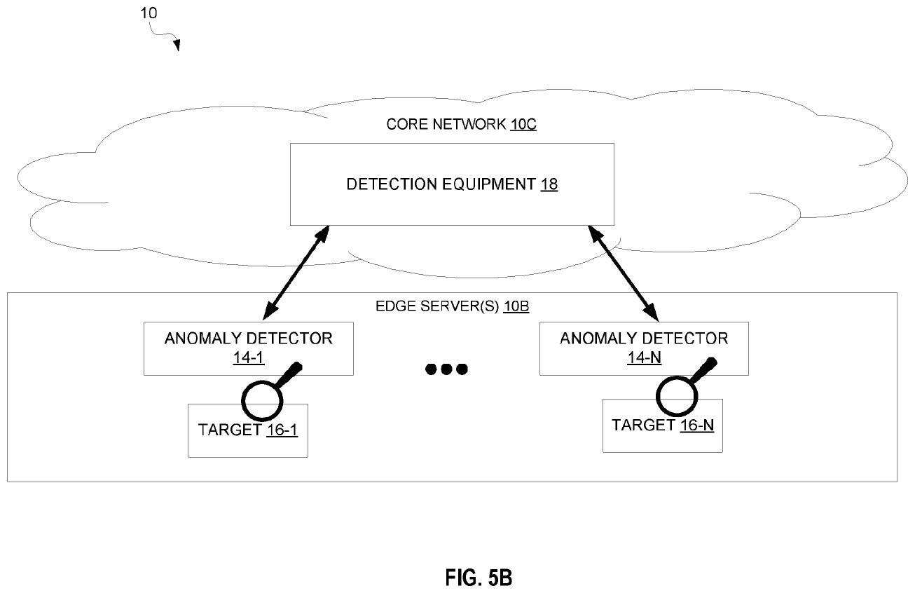

In one embodiment, the detection equipment 18 is deployed at a higher hierarchical level than the anomaly detectors 14, e.g., in order to facilitate anomaly report collection and analysis and/or detector coordination. FIGS. 5A-5B show two examples. As shown in FIG. 5A, the anomaly detectors 14-1 . . . 14-N are deployed in an access network 10A of the communication network 10. The anomaly detectors 14-1 . . . 14-N may for example be distributed at different respective radio access nodes (e.g., base stations) in the access network 10A, for detecting anomalies at the radio network nodes. In this case, the anomaly detectors 14 may take the form of detection ‘agents’ in the radio access network, and so may be appropriately referred to as Radio Attacks Detection Agents (RADAs) when configured to detect anomalies in the form of attacks. The targets 16-1 . . . 16-N in these and other embodiments may take the form of different radio network nodes. In one such embodiment shown in FIG. 5A, the detection equipment 18 is deployed in an edge server 10B, e.g., to monitor for attacks targeting the edge server 10B and/or communication between the access network 10A and the edge server 10B. In this case, the detection equipment 18 may be or be a part of a so-called Edge Attacks Detection Agent (EADA). The edge server 10B may for example be a multi-access edge computing (MEC) server which provides cloud computing capabilities at an edge of the communication network 10, e.g., to provide applications closer to the end users and/or computing services closers to application data.

In other embodiments shown in FIG. 5B, the anomaly detectors 14-1 . . . 14-N are deployed at edge server(s) 10B. In one such embodiment, at least some anomaly detectors 14 are distributed at different edge servers 10B for detecting anomalies at those different edge servers 10B, i.e., the targets 16 are the edge servers 10B or one or more components of the edge servers 10B. In this case, the anomaly detectors 14 may take the form of detection ‘agents’ in the edge network, and so may be or be a part of Edge Attacks Detection Agents (EADAs) when configured to detect anomalies in the form of attacks. In one or more of these embodiments, the detection equipment 18 may be deployed in a core network 10C of the communication network 10, e.g., at core network functions such as Access and Mobility Management Function (AMF), Session Management Function (SMF), Network Slice Selection Function (NSSF), Policy Control Function (PCF), or Unified Data Management (UDM) in a 5G network. In this case, the detection equipment 18 may be or be a part of a so-called Core Attacks Detection Agent (CADA), e.g., for detecting internal attacks that occur within the core network 10C.

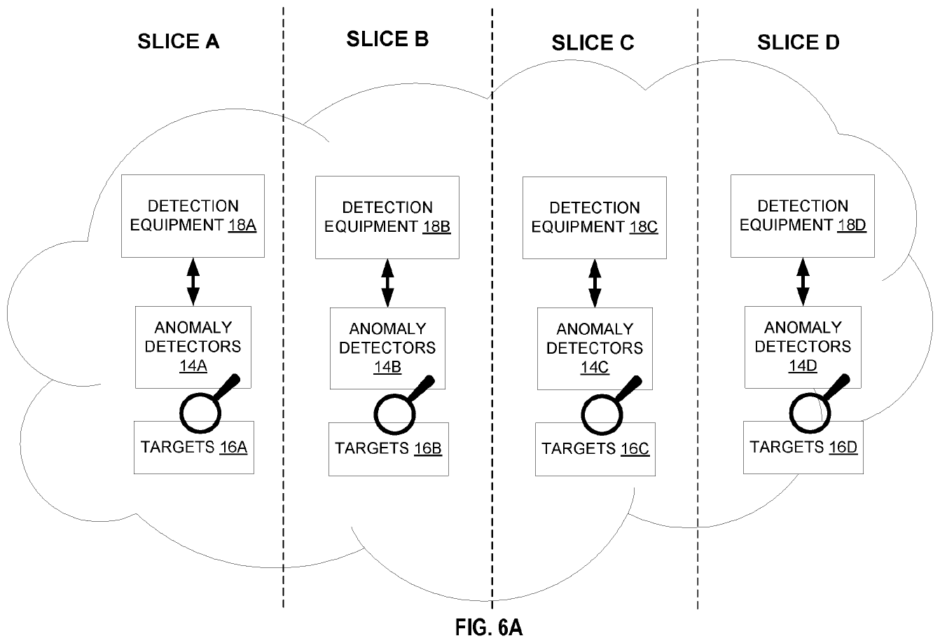

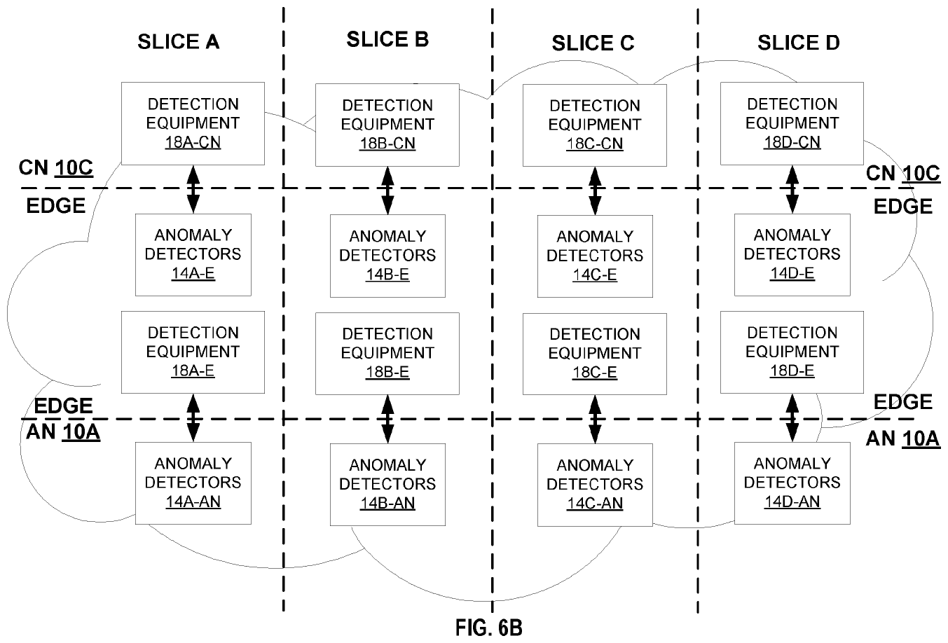

Note that, in embodiments where the communication network 10 deploys multiple network slices, the detection equipment 18 and each of the anomaly detectors 14 discussed herein may be specific for a certain network slice. FIG. 6A for example shows that the communication network 10 may include four slices A-D, with detection equipment and anomaly detectors specific for each slice. Indeed, as shown, detection equipment 18A and each of multiple anomaly detectors 14A are specific for detecting anomalies at targets 16A in network slice A, detection equipment 18AB and each of multiple anomaly detectors 14B are specific for detecting anomalies at targets 16B in network slice B, detection equipment 18C and each of multiple anomaly detectors 14C are specific for detecting anomalies at targets 16C in network slice C, and detection equipment 18D and each of multiple anomaly detectors 14D are specific for detecting anomalies at targets 16D in network slice D.

Note, too, that detection equipment 18 and anomaly detectors 14 may be deployed at multiple hierarchical layers in duplicate, i.e., so as to combine embodiments in FIGS. 5A and 5B. As shown in FIG. 6B, then, network slice A is secured by detection equipment 18A-CN deployed in the core network 10C, anomaly detectors 14A-E deployed in the edge network, detection equipment 18A-E deployed in the edge network, and anomaly detectors 14A-AN deployed in the access network 10A. network slice B is secured by detection equipment 18B-CN deployed in the core network 10C, anomaly detectors 14B-E deployed in the edge network, detection equipment 18B-E deployed in the edge network, and anomaly detectors 14B-AN deployed in the access network 10A. Network slice C is secured by detection equipment 18C-CN deployed in the core network 10C, anomaly detectors 14C-E deployed in the edge network, detection equipment 18C-E deployed in the edge network, and anomaly detectors 14C-AN deployed in the access network 10A. And network slice D is secured by detection equipment 18D-CN deployed in the core network 10C, anomaly detectors 14D-E deployed in the edge network, detection equipment 18D-E deployed in the edge network, and anomaly detectors 14D-AN deployed in the access network 10A.

Separately or in combination with the above embodiments, some embodiments herein control the extent to which a network slice of the communication network 10 is isolated from other network slice(s). Some embodiments do so as a function of how accurately anomalies in a network slice have been detected, e.g., by anomaly detectors 14 and/or detection equipment 18.

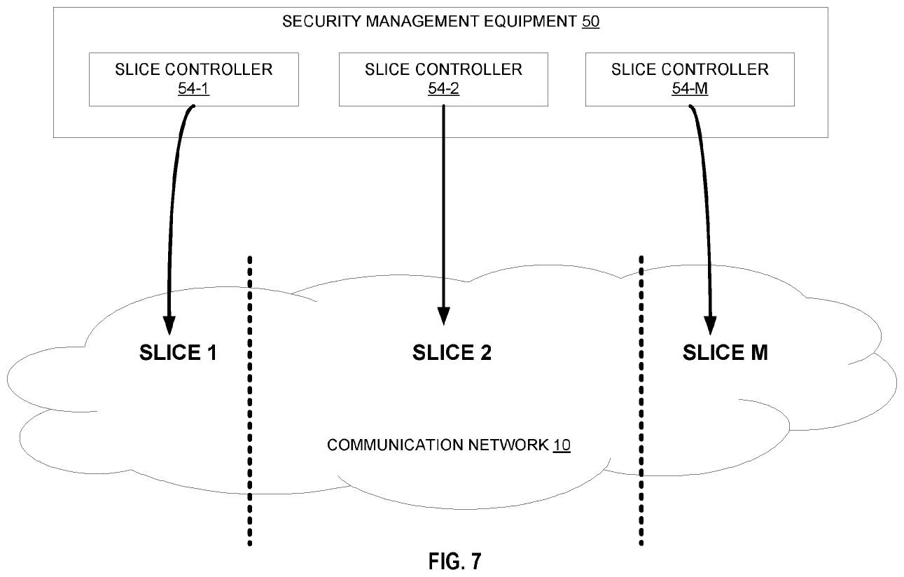

More particularly in this regard, FIG. 7 shows security management equipment 50 according to some embodiments, e.g., implementing an Ericsson Security Manager (ESM). The security management equipment 50 functionally includes slice controllers 54-1 . . . 54-M that control respective network slices 1 . . . M of the communication network 10. The slice controller 54-m for a given network slice m may for example control how isolated that network slice m is from other network slices in the communication network 10.

On this point, network slices 1 . . . M of the communication network 10 may be isolated from one another to a nominal extent, i.e., in the normal course of operation. The level of isolation in this nominal state may vary depending on slicing requirements and usage scenarios. The nominal extent of isolation may for example reflect the extent to which communication is prohibited or allowed between network slices, the extent to which physical equipment is shared or spanned between network slices, the extent to which a communication device is allowed to connect to multiple slices, etc.

In this context, the security management equipment 50 herein may control how isolated each network slice is from other network slices in the sense that the security management equipment 50 may adapt the extent to which each network slice is isolated, e.g., to vary from the nominal extent to which the slice is isolated. The security management equipment 50 may for example control network slice isolation by controlling the activation or configuration of slice isolation technologies, such as tag-based network slice isolation (e.g., Multi-Protocol Label Switching, MPLS), VLAN-based network slice isolation, VPN-based network slice isolation, SDN-based network slice isolation, and/or isolation via slice scheduling or traffic shaping.

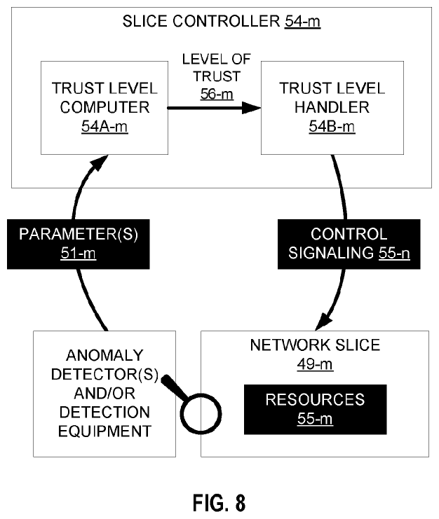

The security management equipment 50 according to some embodiments herein controls network slice isolation as a function of a level of trust to be given to each network slice. A network slice given a lower level of trust is isolated more than a network slice given a higher level of trust. For example, in some embodiments, the security management equipment 50 increase isolation of a network slice if the level of trust to be given to that network slice is below a threshold level of trust. FIG. 8 illustrates additional details in this regard, from the perspective of a slice controller 54-m for a particular network slice 49-m in the communication network 10.

As shown in FIG. 8, the slice controller 54-m includes a trust level computer 54A-m and a trust level handler 54B-m. The trust level computer 54A-m computes a level of trust 56-m to be given to the network slice 49-m. The trust level handler 54B-m controls how isolated the network slice 49-m is from other network slices, based on the level of trust 54-m to be given to that network slice 49-m, e.g., by increasing isolation if the level of trust 54-m is below a threshold level. The trust level handler 54B-m as shown for example transmits control signaling 55-n that controls the extent to which the network slice 49-m is isolated, e.g., by governing activation or configuration of technologies for isolating the network slice 49-m.

In some embodiments, the trust level computer 54A-m computes the level of trust 56-m to account for how accurately anomalies in the network slice 49-m have been detected. FIG. 8 shows for example that the trust level computer 54A-m receives as input one or more parameters 51-m from anomaly detector(s) 14 and/or detection equipment 18 as described above, e.g., where the anomaly detector(s) 14 and/or detection equipment 18 may collaborate to compute and/or signal the parameter(s) 51-m. The parameter(s) 51-m may convey information about how accurately anomalies in the network slice 49-m have been detected. For example, the parameter(s) 51-m may include one or more reputation scores 22 for one or more anomaly detectors 14 for the network slice 49-m. As another example, the parameter(s) 51-m may alternatively or additionally include a false positive rate and/or false negative rate of anomaly detection in the network slice 49-m, where the false positive rate is the rate at which anomalies in the network slice 49-m have been incorrectly detected, and the false negative rate is the rate at which anomalies have failed to be detected in the network slice 49-m. Here, the false positive rate and/or the false negative rate for the network slice 49-m as a whole may be a combination (e.g., sum or average) of the false positive rate and/or the false negative rate of each anomaly detector 14 for the network slice 49-m. Regardless of the particular metric(s) representing how accurately anomalies in the network slice 49-m have been detected, in some embodiments, the level of trust 56-m is proportional to anomaly detection accuracy, e.g., the level of trust 56-m linearly increases with increasing anomaly detection accuracy.

Alternatively or additionally, the trust level computer 54A-m computes the level of trust 56-m to account for how impactful anomaly detection in the network slice 49-m is on resources in the communication network 10, e.g., resources 55-m of the network slice 49-m. For example, the level of trust 56-m may be computed to account for an extent to which resources 55-m required for detecting anomalies in the network slice 49-m, e.g., with at least a threshold level of accuracy, are consumed. In these and other embodiments, then, the level of trust 56-m may decrease with increasing resource strain on the communication network 10.

Consider now a specific example where the level of trust 56-m is computed to account for both how accurately anomalies in the network slice 49-m have been detected and how impactful anomaly detection in the network slice 49-m is on resources in the communication network 10. In this example, the level of trust is computed for the network slice 49-m as a function of a known anomaly detection rate, an unknown anomaly detection rate, a relative information rate, a false positive rate, a false negative rate, and/or a network cost rate. Here, the known and unknown anomaly detection rates are rates at which anomalies of known and unknown types have been detected in the network slice 49-m, respectively. The relative information rate is the rate of anomaly reports from anomaly detectors 14 that is required to detect anomalies in the network slice 49-m with a threshold level of accuracy. The false positive rate is the rate at which anomalies in the network slice 49-m have been incorrectly detected, and the false negative rate is the rate at which anomalies have failed to be detected in the network slice 49-m. The network cost rate is the rate of resources 55-m required for detecting anomalies in the network slice 49-m with a threshold level of accuracy.

As one formulation in these embodiments where anomaly detectors 14 and detection equipment 18 are deployed at different hierarchical levels, e.g., as in FIG. 6B, the level of trust 56-m may be computed for the network slice 49-m as:

$$T = β * {T}_{G} - {β}^{′} * {T}_{B}$$

$${T}_{G} = {D}_{RADA} + {D}_{EADA} + {D}_{EADA}^{′} + {D}_{CADA}^{′} + {RIT}_{RADA} + {RIT}_{EADA}$$

$${T}_{B} = {F}_{RADA} + {F}_{EADA} + {F}_{CADA} + {NCR}_{RADA} + {NCR}_{EADA} + {NCR}_{CADA} .$$

Here, T is the level of trust 56-m for the network slice 49-m.
β and β′∈[0,1] are weight parameters.
T_{G} is a good trust level parameter, whereas T_{B} is a bad trust level parameter.
D_{RADA} is the known anomaly detection rate in the access network 10A of the communication network 10, e.g., the number of known anomalies detected in the access network 10A divided by the total number of anomalies detected in both the access network 10A and the one or more edge servers 10B. Note that an anomaly is known if it has been previously detected and identified as being of a certain type and/or as having certain characteristics or features. On the other hand, an anomaly is unknown if it has not been previously detected or has not been identified as being of a certain type and/or as having certain characteristics or features.
D_{EADA} is the known anomaly detection rate in one or more edge servers 10B of the communication network 10, e.g., the number of known anomalies detected at one or more edge servers 10B divided by the total number of anomalies detected in both the access network 10A and the one or more edge servers 10B.
D′_{EADA} is the unknown anomaly detection rate in one or more edge servers 10B of the communication network 10, e.g., the number of unknown anomalies detected at one or more edge servers 10B divided by the total number of anomalies detected in both the core network 10C and the one or more edge servers 10B.
D′_{CADA} is the unknown anomaly detection rate in the core network 100 of the communication network 10, e.g., the number of unknown anomalies detected in the core network 10C divided by the total number of anomalies detected in both the core network 10C and the one or more edge servers 10B.
RIT_{RADA} is the relative information rate for the anomaly detectors 14 distributed in the access network 10A, e.g., the number of anomaly reports that allow for an accurate detection of known and unknown anomalies in the access network 10A divided by the total number of anomaly reports.
RIT_{EADA} is the relative information rate for the one or more anomaly detectors 14 in the one or more edge servers 10B, e.g., the number of anomaly reports that allow for an accurate detection of known and unknown anomalies in the edge server(s) 10B divided by the total number of anomaly reports.
F_{RADA} is an access network false detection rate comprising a sum of the false negative rate and the false positive rate for the anomaly detectors 14 distributed in the access network 10A, e.g., the number of false detections in the access network 10A divided by the total number of anomalies detected in the access network 10A.
F_{EADA} is an edge false detection rate comprising a sum of the false negative rate and the false positive rate for the one or more anomaly detectors 14 in the one or more edge servers 10B, e.g., the number of false detections in the edge server(s) 10B divided by the total number of anomalies detected in the edge server(s) 10B.
And F_{EADA} is a core network false detection rate comprising a sum of the false negative rate and the false positive rate in the core network 10C, e.g., the number of false detections in the core network 10C divided by the total number of anomalies detected in the core network 10C.
NCR_{RADA} is the network cost rate for the anomaly detectors 14 distributed in the access network 10A, e.g., corresponding to the resources (e.g., computation overhead) required to achieve a high level of security (detect known and unknown anomalies with at least a threshold level of accuracy). The network cost rate in some embodiments converges to one when the total resources required are consumed; otherwise the network cost rate is close to zero.
NCR_{EADA} is the network cost rate for the one or more anomaly detectors 14 in the one or more edge servers 10B, and NCR_{CADA} is the network cost rate in the core network 100.

In some embodiments, the security manager equipment 50 and the anomaly detector(s) 14 and/or the detection equipment 18 effectively collaborate or cooperate with a goal to increase the level of trust T. However, the goal of attackers may be understood as targeting a decrease in the level of trust T. In one embodiment, then, the trust level computer 54A-m instead formulates the level of trust 56-m as a min max function:

$${T}^{*} = {max}_{{T}_{B}} {min}_{{T}_{G}} T ( {T}_{G} , {T}_{B} )$$

In this case, the slice controller 54-m increases isolation of the network slice 49-m if β′*T_{B}>>β*T_{G} and |T*| is less than a threshold (e.g., close to zero).

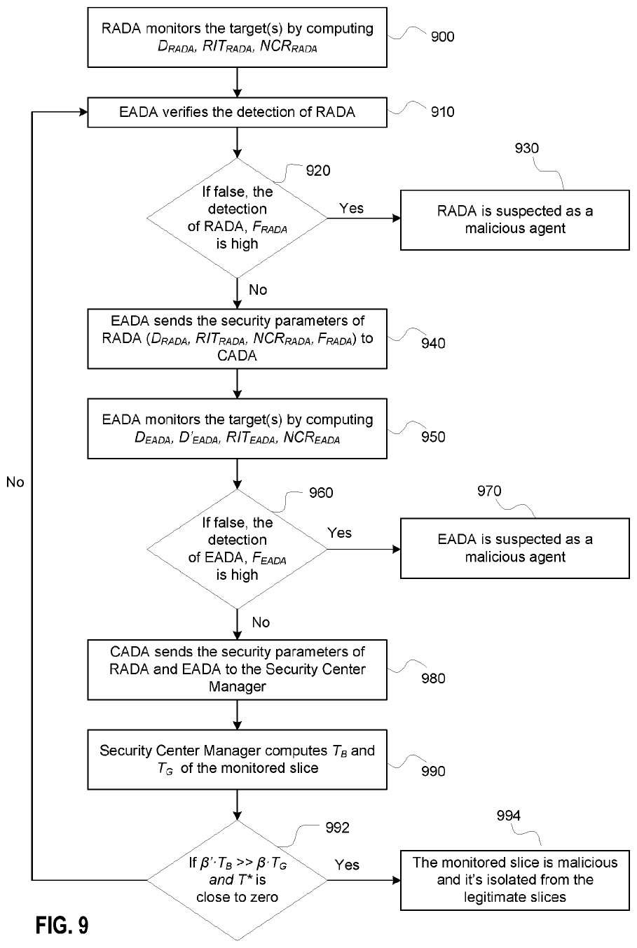

FIG. 9 illustrates a logic flow diagram for one or more such embodiments where the security management equipment 50 is implemented by a Security Center Manager and EADA verifies the detection of anomalies provided by RADA, i.e., EADA verifies if the detected anomaly by RADA corresponds to an anomaly or a normal behavior (and RADA computes false detection rate). In particular, in Step 900, RADA monitors the target(s) by computing D_{RADA}, RIT_{RADA}, NCR_{RADA}. EADA then verifies the detection of RADA (Step 910). If false, EADA determines whether the detection of RADA (F_{RADA}) is high (Block 920). If so (YES at Block 920), RADA is suspected as a malicious agent (Block 930). If not (NO at Block 920), EADA sends the security parameters of RADA (D_{RADA}, RIT_{RADA}, NCR_{RADA}, F_{RADA}) to CADA (Block 940). EADA then monitors the target(s) by computing D_{EADA}, D′_{EADA}, RIT_{EADA}, NCR_{EADA} (Block 950). If false, the CADA determines whether the detection of EADA F_{EADA} is high (Block 960). If so (YES at Block 970), EADA is suspected as a malicious agent (Block 970). If not (NO at Block 970), CADA sends the security parameters of RADA and EADA to the Security Center Manager (Block 980). The Security Center Manager then computes T_{B} and T_{G} of the monitored slice (Block 990) and determines if β′·T_{B}>>, β·T_{G} and T* is close to zero (Block 992). If so (YES at Block 992), the monitored slice is deemed malicious and it is isolated from the legitimate slices block 994).

Regardless of the particular formulation, though, by controlling network slice isolation as described above, some embodiments herein dynamically impose network slice isolation to an extent and/or under circumstances reflecting desired levels of detection accuracy and resource efficiency. In some embodiments, this operates to effectively isolate malicious network slices from legitimate slices, while considering the tradeoff between security performance and network performance. Some embodiments thereby achieve a better quality of service and/or quality of experience.

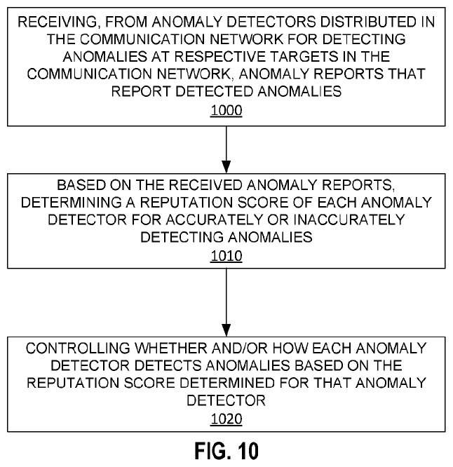

In view of the modifications and variations herein, FIG. 10 depicts a method performed by a detection equipment 18 for a communication network 10 in accordance with particular embodiments. The method includes receiving, from anomaly detectors 14 distributed in the communication network 10 for detecting anomalies at respective targets 16 in the communication network 10, anomaly reports 20 that report detected anomalies (Block 1000). The method also includes, based on the received anomaly reports 20, determining a reputation score 22 of each anomaly detector 14 for accurately or inaccurately detecting anomalies (Block 1010). The method further includes controlling whether and/or how each anomaly detector 14 detects anomalies based on the reputation score 22 determined for that anomaly detector 14 (Block 1020).

In some embodiments, controlling how an anomaly detector detects anomalies comprises selecting, based on the reputation score determined for the anomaly detector, a detection technique for the anomaly detector from among multiple detection techniques supported by the anomaly detector for detecting anomalies. In some embodiments, controlling how an anomaly detector detects anomalies comprises requesting or directing the anomaly detector to use the selected detection technique for detecting anomalies. In some embodiments, selecting the detection technique for the anomaly detector comprises selecting a first detection technique over a second detection technique if the reputation score of the anomaly detector for detecting anomalies accurately is below a first threshold. In other embodiments, selecting the detection technique for the anomaly detector comprises selecting the second detection technique over the first detection technique if the reputation score of the anomaly detector for detecting anomalies accurately is above a second threshold. In some embodiments, the first detection technique detects anomalies more accurately than the second detection technique but requires more resources than the second detection technique. In some embodiments, the detection techniques supported by at least one anomaly detector include at least a machine learning algorithm trained, using training data, to detect anomalies at the target monitored by the anomaly detector. In some embodiments, the detection techniques supported by at least one anomaly detector include at least a rule-based algorithm that detects anomalies at the target monitored by the anomaly based on one or more rules.

In some embodiments, the reputation score of an anomaly detector is determined as a function of a false positive rate and/or a false negative rate. In some embodiments, the false positive rate is a rate at which the anomaly detector incorrectly detects an anomaly, and the false negative rate is a rate at which the anomaly detector fails to detect an anomaly. In some embodiments, the reputation score of an anomaly detector is determined as:

$$R = {α}_{1} \cdot D - ( {α}_{2} \cdot {F}_{P} + {α}_{3} \cdot {F}_{N} ) ,$$

where R∈[−1,1] is the reputation score of the anomaly detector, α₁, α₂ and α₃∈[0,1] are weight parameters, D is a number of anomalies detected by the anomaly detector as reported over K anomaly reports, F_{P} is the false positive rate comprising a number of anomalies that were incorrectly detected by the anomaly detector over K anomaly reports, F_{N} is the false negative rate comprising a number of anomalies that the anomaly detector failed to detect over K anomaly reports. In some embodiments, controlling how an anomaly detector detects anomalies comprises controlling the anomaly detector to detect anomalies using a machine learning algorithm if the reputation score of the anomaly detector is less than 0. In this case, the machine learning algorithm is trained, using training data, to detect anomalies at the target monitored by the anomaly detector. In other embodiments, controlling how an anomaly detector detects anomalies comprises controlling the anomaly detector to detect anomalies using a rule-based algorithm that detects anomalies at the target monitored by the anomaly based on one or more rules, if the reputation score of the anomaly detector is greater than 0.

In some embodiments, the anomaly detectors are deployed in an access network of the communication network and the detection equipment is deployed at an edge server of the communication network. In other embodiments, the anomaly detectors are deployed at one or more edge servers of the communication network and the detection equipment is deployed in a core network of the communication network.

In some embodiments, controlling whether each anomaly detector detects anomalies based on the reputation score determined for that anomaly detector comprises inactivating or isolating the anomaly detector if the reputation score of that anomaly detector drops below a threshold.

In some embodiments, the detection equipment and each of the anomaly detectors is specific for a certain network slice of multiple network slices of the communication network.

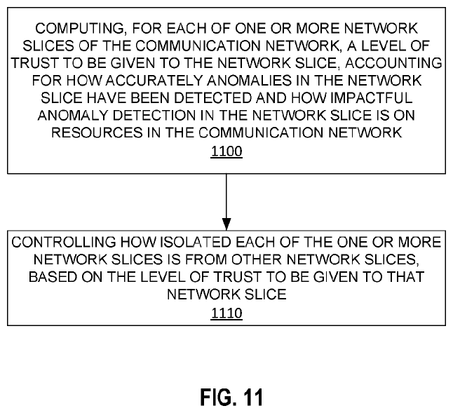

FIG. 11 depicts a method performed by security management equipment 50 for a communication network 10 in accordance with other particular embodiments. The method includes computing, for each of one or more network slices of the communication network 10, a level of trust 56 to be given to the network slice, accounting for how accurately anomalies in the network slice have been detected and how impactful anomaly detection in the network slice is on resources in the communication network 10 (Block 1100). The method also includes controlling how isolated each of the one or more network slices is from other network slices, based on the level of trust 56 to be given to that network slice (Block 1110).

In some embodiments, the detection equipment is configured to perform the steps described above for detection equipment for a communication network.

In some embodiments, a computer program comprising instructions which, when executed by at least one processor of detection equipment, causes the detection equipment to perform the steps described above for detection equipment for a communication network. In some embodiments, a carrier containing the computer program is one of an electronic signal, optical signal, radio signal, or computer readable storage medium.

Other embodiments herein include a method performed by security management equipment for a communication network. The method comprises computing, for each of one or more network slices of the communication network, a level of trust to be given to the network slice, accounting for how accurately anomalies in the network slice have been detected and how impactful anomaly detection in the network slice is on resources in the communication network. In this case, the method also comprises controlling how isolated each of the one or more network slices is from other network slices, based on the level of trust to be given to that network slice.

In some embodiments, said controlling comprises increasing isolation of a network slice if the level of trust to be given to that network slice is below a threshold level of trust.

In some embodiments, the level of trust computed for each network slice accounts for how accurately anomalies in the network slice have been detected by accounting for a false positive rate and/or a false negative rate of anomaly detection in the network slice. In this case, the false positive rate is a rate at which anomalies in the network slice have been incorrectly detected, and the false negative rate is a rate at which anomalies have failed to be detected in the network slice.

In some embodiments, the level of trust computed for each network slice accounts for how impactful anomaly detection in the network slice is on resources in the communication network by accounting for an extent to which resources required for detecting anomalies in the network slice with a threshold level of accuracy are consumed.

In some embodiments, the level of trust is computed for each network slice as a function of at least a known anomaly detection rate comprising a rate at which anomalies of known type have been detected in the network slice. In other embodiments, the level of trust is computed for each network slice alternatively or additionally as a function of at least an unknown anomaly detection rate comprising a rate at which anomalies of unknown type have been detected in the network slice. In yet other embodiments, the level of trust is computed for each network slice alternatively or additionally as a function of at least a relative information rate comprising a rate of anomaly reports from anomaly detectors required to detect anomalies in the network slice with a threshold level of accuracy. In still yet other embodiments, the level of trust is computed for each network slice alternatively or additionally as a function of at least a false positive rate comprising a rate at which anomalies in the network slice have been incorrectly detected. In still yet other embodiments, the level of trust is computed for each network slice alternatively or additionally as a function of at least a false negative rate comprising a rate at which anomalies have failed to be detected in the network slice. In still yet other embodiments, the level of trust is computed for each network slice alternatively or additionally as a function of at least a network cost rate comprising a rate of resources required for detecting anomalies in the network slice with a threshold level of accuracy. In some embodiments, the level of trust is computed for each network slice as:

$$T = β * {T}_{G} - {β}^{′} * {T}_{B}$$

$${T}_{G} = {D}_{RADA} + {D}_{EADA} + {D}_{EADA}^{′} + {D}_{CADA}^{′} + {RIT}_{RADA} + {RIT}_{EADA}$$

$${T}_{B} = {F}_{RADA} + {F}_{EADA} + {F}_{CADA} + {NCR}_{RADA} + {NCR}_{EADA} + {NCR}_{CADA} .$$

In some embodiments, T is the level of trust for the network slice, β and β′∈[0,1] are weight parameters, T_{G} is a good trust level parameter, T_{B} is a bad trust level parameter, D_{RADA} is the known anomaly detection rate in an access network of the communication network, D_{EADA} is the known anomaly detection rate in one or more edge servers of the communication network, D′_{EADA} is the unknown anomaly detection rate in one or more edge servers of the communication network, D′_{CADA} is the unknown anomaly detection rate in a core network of the communication network, RIT_{RADA} is the relative information rate in the access network, RIT_{EADA} is the relative information rate in the one or more edge servers, F_{RADA} is an access network false detection rate comprising a sum of the false negative rate and the false positive rate in the access network, F_{EADA} is an edge false detection rate comprising a sum of the false negative rate and the false positive rate in the one or more edge servers, F_{EADA} is a core network false detection rate comprising a sum of the false negative rate and the false positive rate in the core network, NCR_{RADA} is the network cost rate in the access network, NCR_{EADA} is the network cost rate in the one or more edge servers, and NCR_{CADA} is the network cost rate in the core network. In some embodiments, said controlling comprises increasing isolation of a network slice if β′*T_{B}>>β*T_{G} and |T*| is less than a threshold, where

$${T}^{*} = {max}_{{T}_{B}} {min}_{{T}_{G}} T ( {T}_{G} , {T}_{B} ) .$$

Embodiments herein also include corresponding apparatuses. Embodiments herein for instance include detection equipment 18 configured to perform any of the steps of any of the embodiments described above for the detection equipment 18.

Embodiments also include detection equipment 18 comprising processing circuitry and power supply circuitry. The processing circuitry is configured to perform any of the steps of any of the embodiments described above for the detection equipment 18. The power supply circuitry is configured to supply power to the detection equipment 18.

Embodiments further include detection equipment 18 comprising processing circuitry. The processing circuitry is configured to perform any of the steps of any of the embodiments described above for the detection equipment 18. In some embodiments, the detection equipment 18 further comprises communication circuitry.

Embodiments further include detection equipment 18 comprising processing circuitry and memory. The memory contains instructions executable by the processing circuitry whereby the detection equipment 18 is configured to perform any of the steps of any of the embodiments described above for the detection equipment 18.

Embodiments herein also include security management equipment 50 configured to perform any of the steps of any of the embodiments described above for the security management equipment 50.

Embodiments also include security management equipment 50 comprising processing circuitry and power supply circuitry. The processing circuitry is configured to perform any of the steps of any of the embodiments described above for the security management equipment 50. The power supply circuitry is configured to supply power to the security management equipment 50.

Embodiments further include security management equipment 50 comprising processing circuitry. The processing circuitry is configured to perform any of the steps of any of the embodiments described above for the security management equipment 50. In some embodiments, the security management equipment 50 further comprises communication circuitry.

Embodiments further include security management equipment 50 comprising processing circuitry and memory. The memory contains instructions executable by the processing circuitry whereby the security management equipment 50 is configured to perform any of the steps of any of the embodiments described above for the security management equipment 50.

More particularly, the apparatuses described above may perform the methods herein and any other processing by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

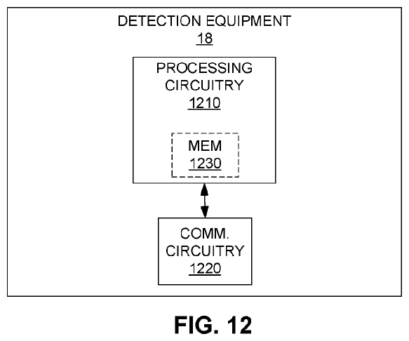

FIG. 12 for example illustrates detection equipment 18 as implemented in accordance with one or more embodiments. As shown, the detection equipment 18 includes processing circuitry 1210 and communication circuitry 1220. The communication circuitry 1220 (e.g., radio circuitry) is configured to transmit and/or receive information to and/or from one or more other nodes, e.g., via any communication technology. The processing circuitry 1210 is configured to perform processing described above, e.g., in FIG. 10, such as by executing instructions stored in memory 1230. The processing circuitry 1210 in this regard may implement certain functional means, units, or modules.

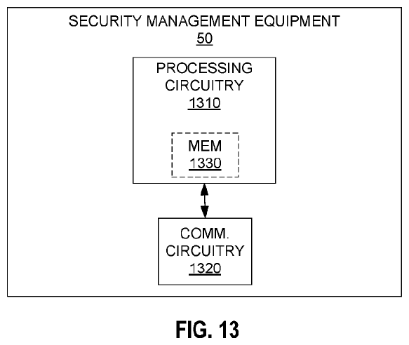

FIG. 13 illustrates security management equipment 50 as implemented in accordance with one or more embodiments. As shown, the security management equipment 50 includes processing circuitry 1310 and communication circuitry 1320. The communication circuitry 1320 is configured to transmit and/or receive information to and/or from one or more other nodes, e.g., via any communication technology. The processing circuitry 1310 is configured to perform processing described above, e.g., in FIG. 11, such as by executing instructions stored in memory 1330. The processing circuitry 1310 in this regard may implement certain functional means, units, or modules.

Those skilled in the art will also appreciate that embodiments herein further include corresponding computer programs.

A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

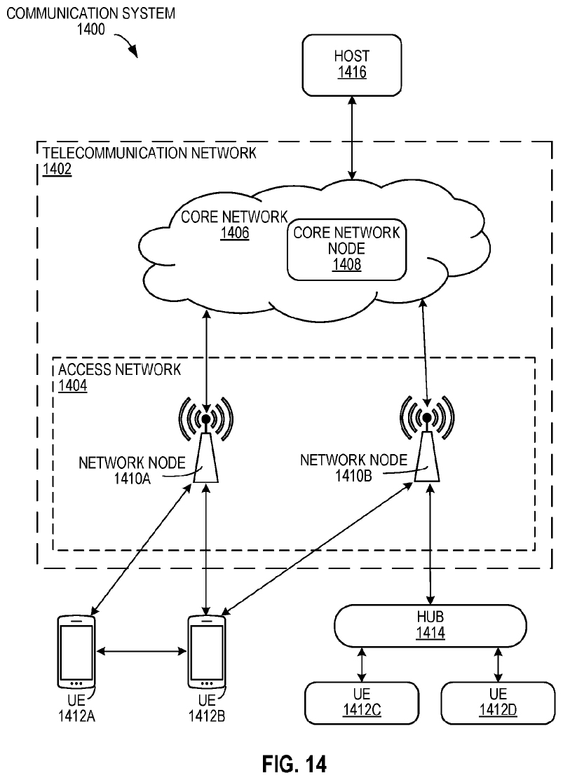

FIG. 14 shows an example of a communication system 1400 in which some embodiments herein are applicable.

In the example, the communication system 1400 includes a telecommunication network 1402 that includes an access network 1404, such as a radio access network (RAN), and a core network 1406, which includes one or more core network nodes 1408. The access network 1404 includes one or more access network nodes, such as network nodes 1410a and 1410b (one or more of which may be generally referred to as network nodes 1410), or any other similar 3^{rd} Generation Partnership Project (3GPP) access node or non-3GPP access point. The network nodes 1410 facilitate direct or indirect connection of user equipment (UE), such as by connecting UEs 1412a, 1412b, 1412c, and 1412d (one or more of which may be generally referred to as UEs 1412) to the core network 1406 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1400 may include any number of wired or wireless networks, network nodes, UEs, and/or any other components or systems that may facilitate or participate in the communication of data and/or signals whether via wired or wireless connections. The communication system 1400 may include and/or interface with any type of communication, telecommunication, data, cellular, radio network, and/or other similar type of system.

The UEs 1412 may be any of a wide variety of communication devices, including wireless devices arranged, configured, and/or operable to communicate wirelessly with the network nodes 1410 and other communication devices. Similarly, the network nodes 1410 are arranged, capable, configured, and/or operable to communicate directly or indirectly with the UEs 1412 and/or with other network nodes or equipment in the telecommunication network 1402 to enable and/or provide network access, such as wireless network access, and/or to perform other functions, such as administration in the telecommunication network 1402.

In the depicted example, the core network 1406 connects the network nodes 1410 to one or more hosts, such as host 1416. These connections may be direct or indirect via one or more intermediary networks or devices. In other examples, network nodes may be directly coupled to hosts. The core network 1406 includes one more core network nodes (e.g., core network node 1408) that are structured with hardware and software components. Features of these components may be substantially similar to those described with respect to the UEs, network nodes, and/or hosts, such that the descriptions thereof are generally applicable to the corresponding components of the core network node 1408. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1416 may be under the ownership or control of a service provider other than an operator or provider of the access network 1404 and/or the telecommunication network 1402, and may be operated by the service provider or on behalf of the service provider. The host 1416 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1400 of FIG. 14 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1402 is a cellular network that implements 3GPP standardized features. Accordingly, the telecommunications network 1402 may support network slicing to provide different logical networks to different devices that are connected to the telecommunication network 1402. For example, the telecommunications network 1402 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1412 are configured to transmit and/or receive information without direct human interaction. For instance, a UE may be designed to transmit information to the access network 1404 on a predetermined schedule, when triggered by an internal or external event, or in response to requests from the access network 1404. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio—Dual Connectivity (EN-DC).

In the example, the hub 1414 communicates with the access network 1404 to facilitate indirect communication between one or more UEs (e.g., UE 1412c and/or 1412d) and network nodes (e.g., network node 1410b). In some examples, the hub 1414 may be a controller, router, content source and analytics, or any of the other communication devices described herein regarding UEs. For example, the hub 1414 may be a broadband router enabling access to the core network 1406 for the UEs. As another example, the hub 1414 may be a controller that sends commands or instructions to one or more actuators in the UEs. Commands or instructions may be received from the UEs, network nodes 1410, or by executable code, script, process, or other instructions in the hub 1414. As another example, the hub 1414 may be a data collector that acts as temporary storage for UE data and, in some embodiments, may perform analysis or other processing of the data. As another example, the hub 1414 may be a content source. For example, for a UE that is a VR headset, display, loudspeaker or other media delivery device, the hub 1414 may retrieve VR assets, video, audio, or other media or data related to sensory information via a network node, which the hub 1414 then provides to the UE either directly, after performing local processing, and/or after adding additional local content. In still another example, the hub 1414 acts as a proxy server or orchestrator for the UEs, in particular in if one or more of the UEs are low energy IoT devices.

The hub 1414 may have a constant/persistent or intermittent connection to the network node 1410b. The hub 1414 may also allow for a different communication scheme and/or schedule between the hub 1414 and UEs (e.g., UE 1412c and/or 1412d), and between the hub 1414 and the core network 1406. In other examples, the hub 1414 is connected to the core network 1406 and/or one or more UEs via a wired connection. Moreover, the hub 1414 may be configured to connect to an M2M service provider over the access network 1404 and/or to another UE over a direct connection. In some scenarios, UEs may establish a wireless connection with the network nodes 1410 while still connected via the hub 1414 via a wired or wireless connection. In some embodiments, the hub 1414 may be a dedicated hub—that is, a hub whose primary function is to route communications to/from the UEs from/to the network node 1410b. In other embodiments, the hub 1414 may be a non-dedicated hub—that is, a device which is capable of operating to route communications between the UEs and network node 1410b, but which is additionally capable of operating as a communication start and/or end point for certain data channels.

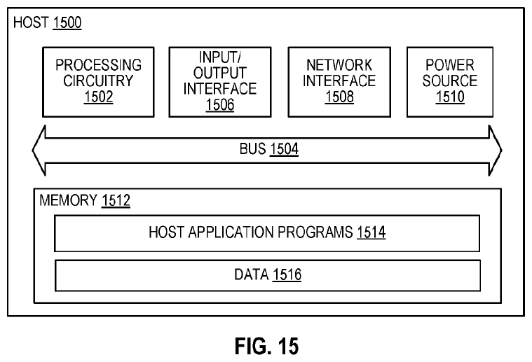

FIG. 15 is a block diagram of a host 1500, which may be an embodiment of the host 1416 of FIG. 14, in accordance with various aspects described herein. As used herein, the host 1500 may be or comprise various combinations hardware and/or software, including a standalone server, a blade server, a cloud-implemented server, a distributed server, a virtual machine, container, or processing resources in a server farm. The host 1500 may provide one or more services to one or more UEs.

The host 1500 includes processing circuitry 1502 that is operatively coupled via a bus 1504 to an input/output interface 1506, a network interface 1508, a power source 1510, and a memory 1512. Other components may be included in other embodiments. Features of these components may be substantially similar to those described with respect to the devices of previous figures, such as FIGS. 15 and QQ3, such that the descriptions thereof are generally applicable to the corresponding components of host 1500.

The memory 1512 may include one or more computer programs including one or more host application programs 1514 and data 1516, which may include user data, e.g., data generated by a UE for the host 1500 or data generated by the host 1500 for a UE.

Embodiments of the host 1500 may utilize only a subset or all of the components shown. The host application programs 1514 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1514 may also provide for user authentication and licensing checks and may periodically report health, routes, and content availability to a central node, such as a device in or on the edge of a core network. Accordingly, the host 1500 may select and/or indicate a different host for over-the-top services for a UE. The host application programs 1514 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

Notably, modifications and other embodiments of the present disclosure will come to mind to one skilled in the art having the benefit of the teachings presented in the foregoing descriptions and the associated drawings. Therefore, it is to be understood that the present disclosure is not to be limited to the specific embodiments disclosed and that modifications and other embodiments are intended to be included within the scope of this disclosure. Although specific terms may be employed herein, they are used in a generic and descriptive sense only and not for purposes of limitation.

1.-29. (canceled)

30. A method performed by detection equipment for a communication network, the method comprising:
receiving, from anomaly detectors distributed in the communication network for detecting anomalies at respective targets in the communication network, anomaly reports that report detected anomalies;
based on the received anomaly reports, determining a reputation score of each anomaly detector for accurately or inaccurately detecting anomalies; and
controlling whether and/or how each anomaly detector detects anomalies based on the reputation score determined for that anomaly detector, wherein controlling how an anomaly detector detects anomalies comprises:
selecting, based on the reputation score determined for the anomaly detector, a detection technique for the anomaly detector from among multiple detection techniques supported by the anomaly detector for detecting anomalies, wherein selecting the detection technique for the anomaly detector comprises selecting a first detection technique over a second detection technique if the reputation score of the anomaly detector for detecting anomalies accurately is below a first threshold or selecting the second detection technique over the first detection technique if the reputation score of the anomaly detector for detecting anomalies accurately is above a second threshold, wherein the first detection technique detects anomalies more accurately than the second detection technique but requires more resources than the second detection technique; and
requesting or directing the anomaly detector to use the selected detection technique for detecting anomalies.

31. The method of claim 30, wherein the detection techniques supported by at least one anomaly detector include at least:
a machine learning algorithm trained, using training data, to detect anomalies at the target monitored by the anomaly detector; and
a rule-based algorithm that detects anomalies at the target monitored by the anomaly based on one or more rules.

32. The method of claim 30, wherein the reputation score of an anomaly detector is determined as a function of a false positive rate and/or a false negative rate, wherein the false positive rate is a rate at which the anomaly detector incorrectly detects an anomaly, and wherein the false negative rate is a rate at which the anomaly detector fails to detect an anomaly.

33. The method of claim 32, wherein the reputation score of an anomaly detector is determined as:
$$R = {α}_{1} \cdot D - ( {α}_{2} \cdot {F}_{P} + {α}_{3} \cdot {F}_{N} ) ,$$
where R∈[−1,1] is the reputation score of the anomaly detector, α₁, α₂ and α₃∈[0,1] are weight parameters, D is a number of anomalies detected by the anomaly detector as reported over K anomaly reports, F_{P} is the false positive rate comprising a number of anomalies that were incorrectly detected by the anomaly detector over K anomaly reports, F_{N} is the false negative rate comprising a number of anomalies that the anomaly detector failed to detect over K anomaly reports.

34. The method of claim 33, wherein controlling how an anomaly detector detects anomalies comprises:
controlling the anomaly detector to detect anomalies using a machine learning algorithm if the reputation score of the anomaly detector is less than 0, wherein the machine learning algorithm is trained, using training data, to detect anomalies at the target monitored by the anomaly detector; or
controlling the anomaly detector to detect anomalies using a rule-based algorithm that detects anomalies at the target monitored by the anomaly based on one or more rules, if the reputation score of the anomaly detector is greater than 0.

35. The method of claim 30, wherein either:
the anomaly detectors are deployed in an access network of the communication network and the detection equipment is deployed at an edge server of the communication network; or
the anomaly detectors are deployed at one or more edge servers of the communication network and the detection equipment is deployed in a core network of the communication network.

36. The method of claim 30, wherein controlling whether each anomaly detector detects anomalies based on the reputation score determined for that anomaly detector comprises inactivating or isolating the anomaly detector if the reputation score of that anomaly detector drops below a threshold.

37. The method of claim 30, wherein the detection equipment and each of the anomaly detectors is specific for a certain network slice of multiple network slices of the communication network.

38. Detection equipment for a communication network, the detection equipment comprising:
communication circuitry; and
processing circuitry configured to:
receive, from anomaly detectors distributed in the communication network for detecting anomalies at respective targets in the communication network, anomaly reports that report detected anomalies;
based on the received anomaly reports, determine a reputation score of each anomaly detector for accurately or inaccurately detecting anomalies; and
control whether and/or how each anomaly detector detects anomalies based on the reputation score determined for that anomaly detector, wherein the processing circuitry is configured to control how an anomaly detector detects anomalies by:
selecting, based on the reputation score determined for the anomaly detector, a detection technique for the anomaly detector from among multiple detection techniques supported by the anomaly detector for detecting anomalies, wherein selecting the detection technique for the anomaly detector comprises selecting a first detection technique over a second detection technique if the reputation score of the anomaly detector for detecting anomalies accurately is below a first threshold or selecting the second detection technique over the first detection technique if the reputation score of the anomaly detector for detecting anomalies accurately is above a second threshold, wherein the first detection technique detects anomalies more accurately than the second detection technique but requires more resources than the second detection technique; and
requesting or directing the anomaly detector to use the selected detection technique for detecting anomalies.

39. The detection equipment of claim 38, wherein the detection techniques supported by at least one anomaly detector include at least:
a machine learning algorithm trained, using training data, to detect anomalies at the target monitored by the anomaly detector; and
a rule-based algorithm that detects anomalies at the target monitored by the anomaly based on one or more rules.

40. The detection equipment of claim 38, wherein the processing circuitry is configured to determine the reputation score of an anomaly detector as a function of a false positive rate and/or a false negative rate, wherein the false positive rate is a rate at which the anomaly detector incorrectly detects an anomaly, and wherein the false negative rate is a rate at which the anomaly detector fails to detect an anomaly.

41. The detection equipment of claim 40, wherein the processing circuitry is configured to determine the reputation score of an anomaly detector as:
$$R = {α}_{1} \cdot D - ( {α}_{2} \cdot {F}_{P} + {α}_{3} \cdot {F}_{N} ) ,$$
where R∈[−1,1] is the reputation score of the anomaly detector, α₁, α₂ and α₃∈[0,1] are weight parameters, D is a number of anomalies detected by the anomaly detector as reported over K anomaly reports, F_{P} is the false positive rate comprising a number of anomalies that were incorrectly detected by the anomaly detector over K anomaly reports, F_{N} is the false negative rate comprising a number of anomalies that the anomaly detector failed to detect over K anomaly reports.

42. The detection equipment of claim 41, wherein the processing circuitry is configured to control how an anomaly detector detects anomalies by:
controlling the anomaly detector to detect anomalies using a machine learning algorithm if the reputation score of the anomaly detector is less than 0, wherein the machine learning algorithm is trained, using training data, to detect anomalies at the target monitored by the anomaly detector; or
controlling the anomaly detector to detect anomalies using a rule-based algorithm that detects anomalies at the target monitored by the anomaly based on one or more rules, if the reputation score of the anomaly detector is greater than 0.

43. The detection equipment of claim 38, wherein either:
the anomaly detectors are deployed in an access network of the communication network and the detection equipment is deployed at an edge server of the communication network; or
the anomaly detectors are deployed at one or more edge servers of the communication network and the detection equipment is deployed in a core network of the communication network.

44. The detection equipment of claim 38, wherein the processing circuitry is configured to control whether each anomaly detector detects anomalies based on the reputation score determined for that anomaly detector by inactivating or isolating the anomaly detector if the reputation score of that anomaly detector drops below a threshold.

45. The detection equipment of claim 38, wherein the detection equipment and each of the anomaly detectors is specific for a certain network slice of multiple network slices of the communication network.

46. A method performed by security management equipment for a communication network, the method comprising:
computing, for each of one or more network slices of the communication network, a level of trust to be given to the network slice, accounting for how accurately anomalies in the network slice have been detected and how impactful anomaly detection in the network slice is on resources in the communication network;
wherein the level of trust is computed for each network slice as a function of one or more of:
a known anomaly detection rate comprising a rate at which anomalies of known type have been detected in the network slice;
an unknown anomaly detection rate comprising a rate at which anomalies of unknown type have been detected in the network slice;
a relative information rate comprising a rate of anomaly reports from anomaly detectors required to detect anomalies in the network slice with a threshold level of accuracy;
a false positive rate comprising a rate at which anomalies in the network slice have been incorrectly detected;
a false negative rate comprising a rate at which anomalies have failed to be detected in the network slice; and/or
a network cost rate comprising a rate of resources required for detecting anomalies in the network slice with a threshold level of accuracy; and
wherein the level of trust is computed for each network slice as:
$$T = β * {T}_{G} - {β}^{′} * {T}_{B}$$
$${T}_{G} = {D}_{RADA} + {D}_{EADA} + {D}_{EADA}^{′} + {D}_{CADA}^{′} + {RIT}_{RADA} + {RIT}_{EADA}$$
$${T}_{B} = {F}_{RADA} + {F}_{EADA} + {F}_{CADA} + {NCR}_{RADA} + {NCR}_{EADA} + {NCR}_{CADA} .$$
wherein T is the level of trust for the network slice, β and β′∈[0,1] are weight parameters, T_{G} is a good trust level parameter, T_{B} is a bad trust level parameter, D_{RADA} is the known anomaly detection rate in an access network of the communication network, D_{EADA} is the known anomaly detection rate in one or more edge servers of the communication network, D′_{EADA} is the unknown anomaly detection rate in one or more edge servers of the communication network, D′_{CADA} is the unknown anomaly detection rate in a core network of the communication network, RIT_{RADA} is the relative information rate in the access network, RIT_{EADA} is the relative information rate in the one or more edge servers, F_{RADA} is an access network false detection rate comprising a sum of the false negative rate and the false positive rate in the access network, F_{EADA} is an edge false detection rate comprising a sum of the false negative rate and the false positive rate in the one or more edge servers, F_{EADA} is a core network false detection rate comprising a sum of the false negative rate and the false positive rate in the core network, NCR_{RADA} is the network cost rate in the access network, NCR_{EADA} is the network cost rate in the one or more edge servers, and NCR_{CADA} is the network cost rate in the core network; and
controlling how isolated each of the one or more network slices is from other network slices, based on the level of trust to be given to that network slice.

47. The method of claim 46, wherein said controlling comprises increasing isolation of a network slice if the level of trust to be given to that network slice is below a threshold level of trust.

48. The method of claim 46, wherein said controlling comprises increasing isolation of a network slice if β′*T_{B}>>*T_{G} and |T*| is less than a threshold, where
$${T}^{*} = {max}_{{T}_{B}} {min}_{{T}_{G}} T ( {T}_{G} , {T}_{B} ) .$$
